(19) United States
(12) Patent Application Publication
(10) Pub. No.: US 2026/0164463 A1
(43) Pub. Date: Jun. 11, 2026

(54) Signaling for User Equipment to Demand MSG3 Repetition

(71) Applicant: Apple Inc., Cupertino, CA (US)

(72) Inventors: Seyed Ali Akbar Fakoorian, San Diego, CA (US); Chunhai Yao, Beijing (CN); Chunxuan Ye, San Diego, CA (US); Dawei Zhang, Saratoga, CA (US); Haitong Sun, Cupertino, CA (US); Hong He, San Jose, CA (US); Oghenekome Oteri, San Diego, CA (US); Sigen Ye, Whitehouse Station, NJ (US); Wei Zeng, Saratoga, CA (US); Weidong Yang, San Diego, CA (US); Yushu Zhang, Beijing (CN)

(21) Appl. No.: 18/707,513

(22) PCT Filed: Nov. 4, 2021
(86) PCT No.: PCT/CN2021/128677

§ 371 Date: May 3, 2024

(51) Int. Cl. H04W 74/0833; H04B 17/318

(52) U.S. Cl. CPC H04W 74/0833; H04B 17/328

(57) ABSTRACT

Systems, methods, and apparatus for a UE to demand message 3 (Msg3) repetition during a contention-based random access (CBRA) procedure are disclosed. In a method of wireless communication by a user equipment (UE), the UE may receive, from a radio access network (RAN), a value targeted to assist the UE in determining whether to demand Msg3 repetition. The UE may perform a measurement on a downlink signal, and determine to demand Msg3 repetition based at least in part on the value targeted to assist the UE in determining whether to demand Msg3 repetition and the measurement on the downlink signal. The UE may transmit, to the RAN, a random access channel (RACH) preamble with Msg3 repetition demand characteristics.

### CROSS-REFERENCE TO RELATED APPLICATION

This application is a 35 U.S.C. § 371 application of PCT/CN2021/128677, filed on Nov. 4, 2021, and entitled “Signaling for User Equipment to Demand MSG3 Repetition,” which is incorporated herein by reference as if fully disclosed herein.

### TECHNICAL FIELD

This application relates generally to wireless communication systems, including methods and implementations of signaling for user equipment (UEs) to demand message 3 (Msg3) repetition.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example flow diagram for a contention-based random access (CBRA) procedure.

FIG. 2 shows example pseudocode defining a procedure for contention-based physical random access channel (PRACH) resource selection by a UE.

FIG. 3 shows example pseudocode defining a procedure for selecting between a normal uplink (NUL) carrier or a supplemental uplink (SUL) carrier for performing a CBRA procedure.

FIG. 4A shows example pseudocode defining a procedure for determining whether Group B random access channel (RACH) preambles are configured.

FIG. 4B shows example pseudocode defining a procedure for selecting a RACH preamble from Group A RACH preambles or Group B RACH preambles.

FIG. 5 shows an example method of a wireless communication by a UE, which method may be used by a UE to demand Msg3 repetition.

FIGS. 6 and 7 show example pseudocode for selecting a RACH preamble from a first group of RACH preambles or a second group of RACH preambles, in which the first group of RACH preambles includes a first subset of RACH preambles that is associated with a demand for Msg3 repetition and a second subset of RACH preambles that is not associated with a demand for Msg3 repetition.

FIG. 8 shows an example method of communication by a RAN (e.g., by a base station of a RAN), which method may be used by the RAN to support Msg3 repetition by one or more UEs.

FIG. 9 illustrates an example architecture of a wireless communication system, according to embodiments disclosed herein.

FIG. 10 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

In 3GPP Release 17 (Rel-17), Msg3 repetition (for initial transmission and for retransmission) during a contention-based random access (CBRA) procedure is supported. Msg3 repetition can be useful for a UE at the edge of a RAN's (or base station's, or gNB's) coverage area, which UE may not be able to transmit a Msg3 at a high enough power for the RAN to reliably receive the Msg3 during a single (or first) transmission of the Msg3. To demand Msg3 repetition, a UE may transmit a RACH preamble associated with Msg3 demand characteristics to the RAN (e.g., to a base station (or gNB) of the RAN). The UE may transmit the RACH preamble on a PRACH, on a RACH occasion (RO) shared with legacy UEs (e.g., UEs that may not demand Msg3 repetition). The RACH preamble associated with Msg3 demand characteristics may be orthogonal to RACH preambles without Msg3 demand characteristics.

It was agreed in RAN1 #105-e that a UE may demand Msg3 repetition on a physical uplink shared channel (PUSCH) at least when a reference signal received power (RSRP) of a downlink signal is lower than an RSRP threshold. However, the nature of the RSRP threshold was left for future study.

The present description describes various systems, methods, and apparatus that enable a UE to demand Msg3 repetition.

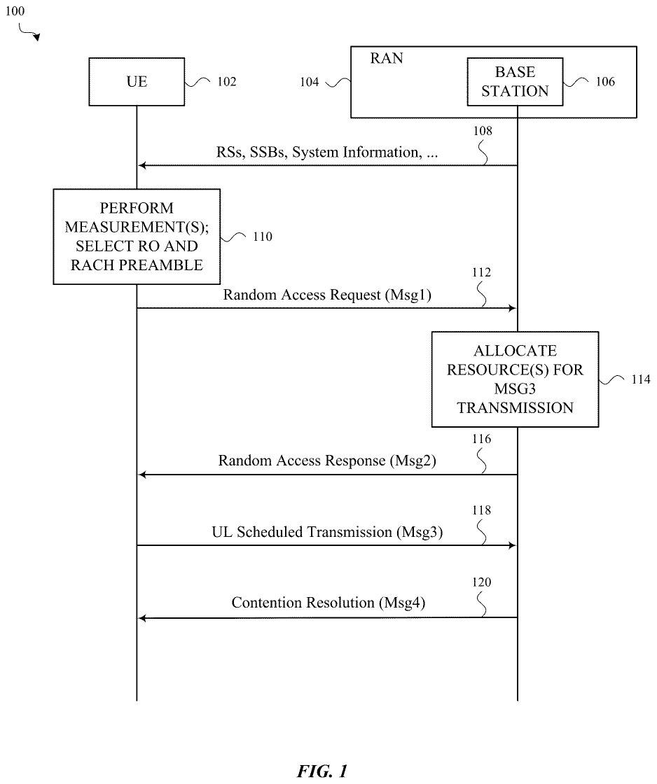

FIG. 1 illustrates an example flow diagram 100 for a CBRA procedure. The messages shown in FIG. 1 are transmitted or received by a UE 102 and a radio access network (RAN) 104, and are typically transmitted or received by the UE 102 and a base station 106 of the RAN 104. In some embodiments, however, messages transmitted or received by the RAN 104 may be transmitted or received by more than one base station (or different base stations) of the RAN 104.

At 108, the RAN 104 (and, more particularly, the base station 106 and/or other base stations of the RAN 104) may transmit (e.g., broadcast) information that is usable by any number of UEs to perform a random access procedure. The information may include, for example, one or more reference signals (RSs), synchronization signal blocks (SSBs), system information, information usable by UEs to determine whether to demand Msg3 repetition, and so on.

At 110, the UE 102 may perform a measurement on a downlink signal received from the RAN 104 (or base station 106). The measurement may in some cases be a RSRP measurement performed on a synchronization signal (SS) received in an SSB. In some cases, the UE 102 may perform the RSRP measurement on SSs associated with different SSBs, and may select a RO for sending a PRACH, including a RACH preamble, to the RAN 104 (or base station 106). In some cases, the UE 102 may determine to demand Msg3 repetition based on the information received at 108 and the measurements it performs at 110.

At 112, the UE 102 may transmit a random access request (e.g., a message 1 (Msg1)) including a RACH preamble to the RAN 104 (or base station 106). In some cases, the RACH preamble may have Msg3 repetition demand characteristics.

At 114, the RAN 104 (or base station 106) may determine whether to allocate resources to the UE 102 for Msg3 repetition. In response to the UE's demand for Msg3 repetition, the RAN 104 (or base station 106) may or may not allocate resources for Msg3 repetition.

At 116, the RAN 104 (or base station 106) may transmit a random access response (e.g., a message 2 (Msg2)) to the UE 102. The random access response may include one or more uplink (UL) grants for Msg3 transmission by the UE 102, and in some cases may include UL grants for Msg3 repetition.

At 118, the UE 102 may transmit UL scheduled transmissions (e.g., Msg3 transmissions, with or without repetition) to the RAN 104 (or base station 106).

At 120, the RAN 104 (or base station 106) may transmit a contention resolution message (e.g., a message 4 (Msg4)) to the UE 102.

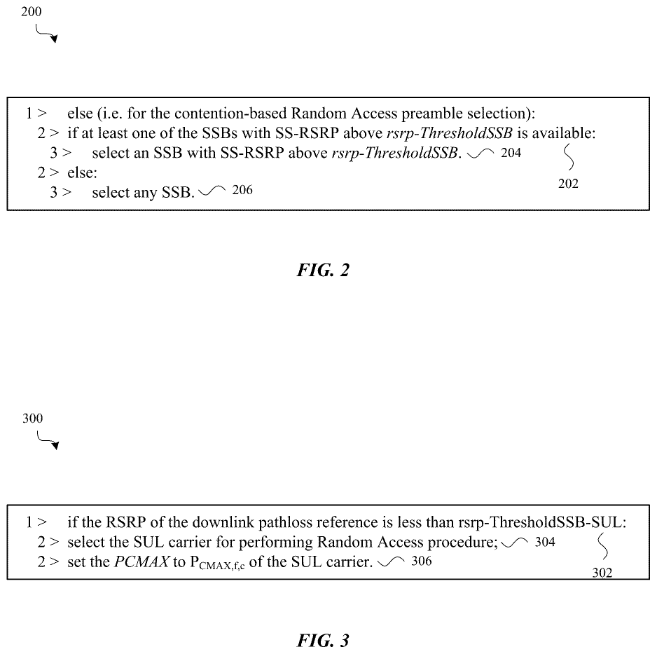

In the current 3GPP specification, a UE may be configured with an RSRP threshold for contention-based PRACH resource selection associated to an SSB. A procedure for contention-based PRACH resource selection is described in 3GPP Technical Specification (TS) 38.321, Section 5.1.2, and is illustrated by the pseudocode 200 shown in FIG. 2. By way of example, the pseudocode 200 may be performed by the UE 102 at 110 of FIG. 1.

At 202, a UE may perform a measurement on a downlink signal associated with an SSB broadcast by a RAN (e.g., by a base station of the RAN). For example, the UE may perform an RSRP measurement on a SS associated with the SSB (e.g., a synchronization signal (SS) associated with an SSB). The RSRP measurement is referred to as an SS-RSRP measurement in FIG. 2, but is referred to as a downlink pathloss measurement, or measurement T, in this description. After performing the SS-RSRP measurement, the UE may determine whether the measurement exceeds an RSRP threshold broadcast by the RAN (e.g., by a base station of the RAN). The RSRP threshold is referred to as rsrp-ThresholdSSB in FIG. 2, but is referred to as a first RSRP threshold or a threshold T1 in this description.

The operations at 202 may be performed on SSs associated with one or more SSBs. At 204, the UE may select an SSB for which T is above (i.e., greater than) T1. In some cases, the UE may select the first SSB for which T is determined to be above T1. If the UE cannot identify an SSB for which T>T1, the UE may select any SSB at 206. Thereafter, the UE may select a PRACH resource (e.g., a RACH preamble and RO) associated with the selected SSB, and continue performing a CBRA procedure.

Also in the current 3GPP specification, a UE may be configured with an RSRP threshold for selecting a normal uplink (NUL) carrier or a supplemental uplink (SUL) carrier for performing a CBRA procedure. A procedure for selecting between a NUL carrier and a SUL carrier is described in 3GPP TS 38.321, Section 5.1.2, and is illustrated by the pseudocode 300 shown in FIG. 3. By way of example, the pseudocode 300 may also be performed by the UE 102 at 110 of FIG. 1.

At 302, the UE may determine whether the SS-RSRP measurement (T) is less than an additional RSRP threshold broadcast by the RAN (e.g., by a base station of the RAN). The additional RSRP threshold is referred to as rsrp-ThresholdSSB-SUL in FIG. 3, but is referred to as a second RSRP threshold or a threshold T2 in this description.

At 304, the UE may select a SUL carrier for performing a CBRA procedure when T<T2. Otherwise, the UE may select a NUL carrier for performing a CBRA procedure when T>T2. At 306, the UE may set the configured maximum output power (PCMAX) for the UE to P_{CMAX,f,c}, where f is the carrier and c is the serving cell.

In 3GPP RAN1 #106b-c, it was agreed that, from the RAN1 perspective, it may be beneficial to separately configure T1 for requesting Msg3 PUSCH repetition with a shared RO on a given UL carrier. It was also agreed that there is no need to separately configure T2 in RACH-ConfigCommon for requesting Msg3 PUSCH repetition with a shared RO on a given UL carrier. It was not determined how RSRP threshold values are used to determine the Msg3 transmission mode (e.g., with or without Msg3 repetition) on a NUL carrier versus a SUL carrier.

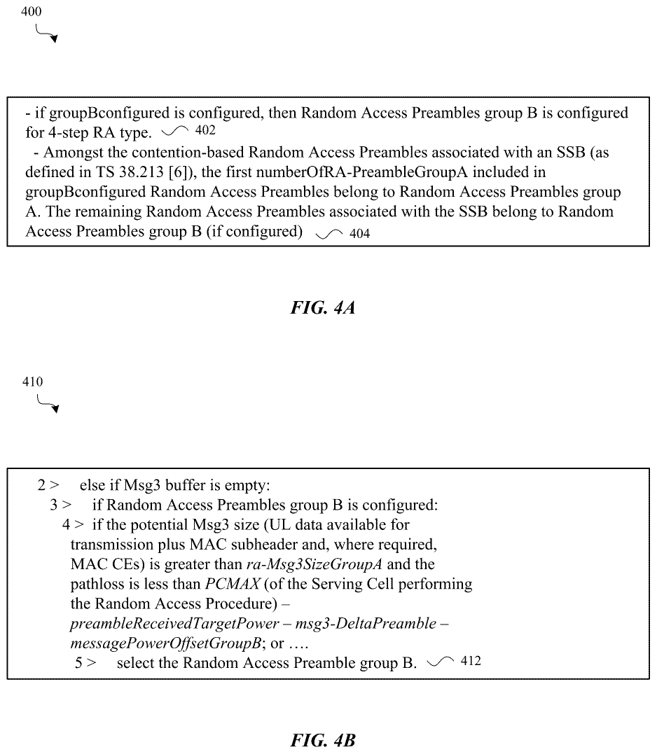

In the current 3GPP specification, a UE may be configured by a RAN (e.g., by groupBconfigured) to select a RACH preamble from one of two groups of RACH preambles, referred to as Group A RACH preambles and Group B RACH preambles. Procedures for determining whether Group B RACH preambles are configured and selecting a RACH preamble from Group A RACH preambles or Group B RACH preambles is described in 3GPP TS 38.321, Section 5.1.1, and are illustrated by the pseudocode 400, 410 shown in FIGS. 4A and 4B. The pseudocode 400 shows a procedure for determining whether Group B RACH preambles are configured. The pseudocode 410 shows a procedure for selecting a RACH preamble from Group A RACH preambles or Group B RACH preambles. By way of example, the pseudocode 400 and 410 may be performed by the UE 102 at 110 of FIG. 1.

At 402 of pseudocode 400, a UE may determine whether Group B RACH preambles are configured by evaluating a value of groupBconfigured. If Group B RACH preambles are configured, the CBRA preambles associated with an SSB (as defined by 3GPP TS 38.213, Section 6) include a first number of RACH preambles belonging to Group A RACH preambles, and a remaining number of RACH preambles belonging to Group B RACH preambles (see, 404).

At 412 of pseudocode 410, a UE may select a RACH preamble from the Group B RACH preambles when a potential Msg3 size (e.g., transport block (TB) size) is greater than a threshold size (i.e., ra-Msg3SizeGroupA) and the downlink pathloss (T) measured by the UE is less than a threshold. Otherwise, the UE may select a RACH preamble from the Group A RACH preambles. The threshold to which the downlink pathloss is compared may be equal to:

$$PCMAX ( of the serving cell performing the random access procedure ) - preambleRecievedTargetPower - msg 3 - DeltaPreamble - messagePowerOffsetGroupB$$

where preambleReceivedTargetPower is a value of a target power for receiving the RACH preamble at the RAN; msg3-DeltaPreamble is a constant; and messagePowerOffsetGroupB is a first value of a message power offset for RACH preamble selection. Values for preambleReceivedTargetPower, msg3-DeltaPreamble, and messagePowerOffsetGroupB may be broadcast by the RAN.

The current 3GPP specification does not indicate if or how Group A and/or Group B RACH preambles may be used to demand Msg3 repetition.

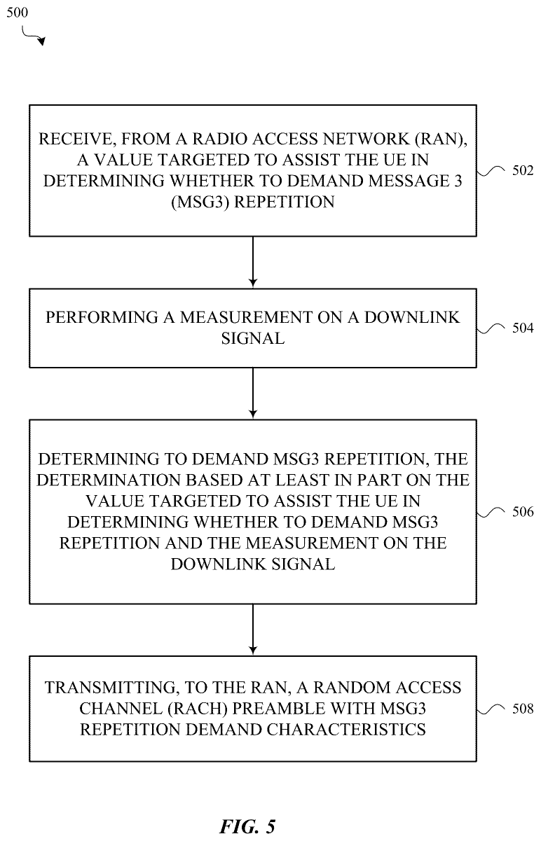

FIG. 5 shows an example method 500 of wireless communication by a UE, which method 500 may be used by a UE to demand Msg3 repetition. The UE that performs the method 500 may be the UE described with reference to any of FIG. 1-4B or 6-10.

At 502, the method 500 may include receiving, from a RAN (e.g., from a base station of a RAN), a value targeted to assist the UE in determining whether to demand Msg3 repetition. In some embodiments, the value may be broadcast to all UEs in a RAN's (or base station's) coverage area. In some embodiments, the operation(s) at 502 may be performed at 108 of the CBRA procedure described with reference to FIG. 1.

At 504, the method 500 may include performing a measurement on a downlink signal. In some embodiments, the measurement may be an SS-RSRP measurement (or measurement T) performed for a particular SSB. In some embodiments, the operation(s) at 504 may be performed at 110 of the CBRA procedure described with reference to FIG. 1.

At 506, the method 500 may include determining to demand Msg3 repetition. The determination may be based at least in part on the value targeted to assist the UE in determining whether to demand Msg3 repetition and the measurement (T) on the downlink signal. In some embodiments, the operation(s) at 506 may be performed at 110 of the CBRA procedure described with reference to FIG. 1.

At 508, the method 500 may include transmitting, to the RAN, a RACH preamble with Msg3 repetition demand characteristics. In some embodiments, the Msg3 repetition demand characteristics may include the UE's selection of a RACH preamble allocated for performing a CBRA procedure with a Msg3 repetition demand. Such a RACH preamble may be identified by the RAN in broadcast information, and in some cases may be part of a particular group of RACH preambles and/or have particular characteristics (e.g., being relatively shorter in length). In some embodiments, the operation(s) at 508 may be performed at 112 of the CBRA procedure described with reference to FIG. 1.

In some embodiments of the method 500, the method 500 may further include receiving, from the RAN (e.g., from a base station), a first RSRP threshold (T1) for SSB selection, and a second RSRP threshold (T2) for SUL carrier selection.

In some embodiments of the method 500, the value targeted to assist the UE in determining whether to demand Msg3 repetition (received at 502) may include a third RSRP threshold (T3). In these embodiments, the third RSRP threshold may assist the UE in determining whether to demand Msg3 repetition on a NUL carrier. In some cases, no additional RSRP threshold need be configured for determining whether to demand Msg3 repetition on a SUL carrier. In these embodiments, T1 should be less than T2 (i.e., T1<T2) and T1 should be less than T3 (i.e., T1<T3), but T2 may be greater or less than T3. These embodiments indicate to a UE that Msg3 repetition may be demanded on a NUL carrier only and, if a RACH preamble is selected by the UE for transmission on an SUL, Msg3 repetition cannot be demanded. In these embodiments, determining to demand Msg3 repetition (at 506) includes determining a value (T) of the measurement on the downlink signal is less than the second RSRP threshold or less than the third RSRP threshold. The RACH preamble is then transmitted on the NUL carrier at 508. In some cases, a UE that determines the value (T) of the measurement on the downlink signal is less than the second RSRP threshold (T2) or less than the third RSRP threshold (T3) may be allowed to perform a CBRA procedure associated with Msg3 repetition on a NUL carrier, or perform a CBRA procedure that is not associated with Msg3 repetition on a SUL carrier. If the UE alternatively determines that the value (T) of the measurement on the downlink signal is greater than both T2 and T3 (i.e., T>max (T2, T3)), then the UE may alternatively perform a CBRA procedure on a NUL carrier, without Msg3 repetition.

In some embodiments of the method 500, the value targeted to assist the UE in determining whether to demand Msg3 repetition (received at 502) may include a third RSRP threshold (T3). In these embodiments, the third RSRP threshold may assist the UE in determining whether to demand Msg3 repetition on a NUL carrier or on a SUL carrier. No additional RSRP threshold need be configured for determining whether to demand Msg3 repetition. In these embodiments, T1 should be less than T2 (i.e., T1<T2) and T1 should be less than T3 (i.e., T1<T3), but T2 may be greater or less than T3. These embodiments implicitly indicate to a UE when Msg3 repetition may be demanded on a NUL carrier, or on a SUL carrier, based on the relationship between T2 and T3. For example, when the UE determines that T2 is less than T3 (i.e., T2<T3), the UE may, in some cases, demand Msg3 repetition on a SUL carrier. However, when the UE determines that T2 is greater than T3 (i.e., T2>T3), the UE may not demand Msg3 repetition on a SUL carrier.

When the UE determines that T₂<T3, the UE may 1) determine to demand Msg3 repetition and transmit a RACH preamble on a SUL carrier when T is less than T2 (i.e., T<T2), or 2) determine to demand Msg3 repetition and transmit a RACH preamble on a NUL carrier when T is between T2 and T3 (i.e., T₂<T<T3). Alternatively, the UE may determine not to demand Msg3 repetition and transmit a RACH preamble on a NUL carrier when T₂<T3 and T is greater than T3 (i.e., T>T3).

When the UE determines that T2>T3, the UE may determine to demand Msg3 repetition and transmit a RACH preamble on a NUL carrier when T is less than T3 (i.e., T<T3). Alternatively, the UE may determine not to demand Msg3 repetition and transmit a RACH preamble on a SUL carrier when T2>T3 and T is between T2 and T3 (i.e., T3<T<T2), or the UE may determine not to demand Msg3 repetition and transmit a RACH preamble on a NUL carrier when T2>T3 and T is greater than T2 (i.e., T>T2).

In some embodiments of the method 500, the value targeted to assist the UE in determining whether to demand Msg3 repetition (received at 502) may include a third RSRP threshold (T3), and the method 500 may further include receiving, from the RAN (e.g., from a base station of the RAN), a fourth RSRP threshold (T4). In these embodiments, the third RSRP threshold may assist the UE in determining whether to demand Msg3 repetition on a NUL carrier, and the fourth RSRP threshold may assist the UE in determining whether to demand Msg3 repetition on a SUL carrier. In these embodiments, T3 should be greater than T4 (i.e., T3>T4) and the condition of T4>T3 is an error case.

When the UE determines that T2 is between T3 and T4 (i.e., T3>T2>T4), the UE may 1) determine to demand Msg3 repetition and transmit a RACH preamble on a NUL carrier when T is between T2 and T3 (i.e., T2<T<T3), or 2) determine to demand Msg3 repetition and transmit a RACH preamble on a SUL carrier when T is less than T4 (i.e., T<T4). Alternatively, the UE may determine not to demand Msg3 repetition and transmit a RACH preamble on a NUL carrier when T3>T2>T4 and T is less than T3 (i.e., T<T3), or the UE may determine not to demand Msg3 repetition and transmit a RACH preamble on a SUL carrier when T3>T2>T4 and T is between T2 and T4 (i.e., T4<T<T2).

When the UE determines that T3 is between T2 and T4 (i.e., T2>T3>T4), the UE may 1) determine to demand Msg3 repetition and transmit a RACH preamble on a NUL carrier when T is between T3 and T4 (i.e., T4<T<T3), or 2) determine to demand Msg3 repetition and transmit a RACH preamble on a SUL carrier when T is less than T4 (i.e., T<T4). Alternatively, the UE may determine not to demand Msg3 repetition and transmit a RACH preamble on a NUL carrier when T2>T3>T4 and T is greater than T2 (i.e., T>T2), or the UE may determine not to demand Msg3 repetition and transmit a RACH preamble on a SUL carrier when T2>T3>T4 and T is between T2 and T3 (i.e., T3<T<T2).

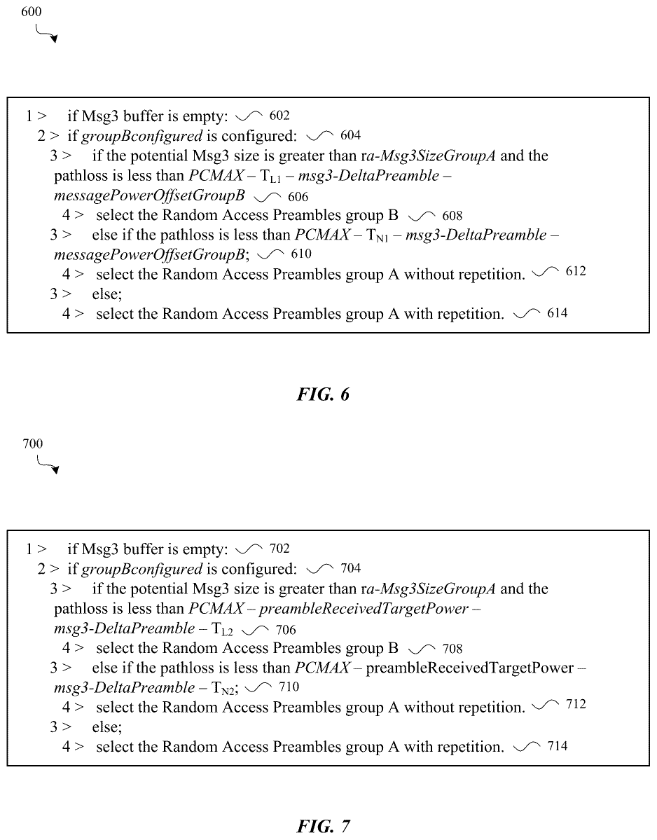

In some embodiments of the method 500, the method 500 may further include determining an availability of a first group of RACH preambles and a second group of RACH preambles (i.e., determining that the first group and the second group are available, or configured). The first group of RACH preambles may be the Group A RACH preambles discussed supra, and the second group of RACH preambles may be the Group B RACH preambles discussed supra and enabled by the groupBconfigured indication. In some forms of these embodiments, the method 500 may further include receiving, from the RAN (e.g., from a base station), a first value (T_{L1}) of a target power for receiving the RACH preamble at the RAN (e.g., preambleReceivedTargetPower); and the value targeted to assist the UE in determining whether to demand Msg3 repetition (received at 502) may include a second value (T_{N1}) of a target power for receiving the RACH preamble at the RAN. In practice, T_{N1}<T_{L1}. An example of these forms of embodiments is illustrated by the pseudocode shown in FIG. 6. In other forms of these embodiments, the method 500 may further include receiving, from the RAN (e.g., from a base station), a first value (T_{L2}) of a message power offset for RACH preamble selection (e.g., messagePowerOffsetGroupB); and the value targeted to assist the UE in determining whether to demand Msg3 repetition (received at 502) may include a second value (T_{N2}) of a message power offset for RACH preamble selection. An example of these latter forms of embodiments is illustrated by the pseudocode shown in FIG. 7.

As shown in FIG. 6, the pseudocode 600 may be triggered when a UE determines (at 602) that a Msg3 buffer is empty and (at 604) that groupBconfigured is configured. If the UE then determines (at 606) that the Msg3 size is greater than ra-Msg3sizeGroupA and the downlink pathloss is less than PCMAX-T_{L1}-msg3-DeltaPreamble-messagePowerOffsetGroupB, the UE may select (at 608) a RACH preamble from the second group of RACH preambles (e.g., the Group B RACH preambles). Otherwise, if the UE determines (at 610) that the downlink pathloss is less than PCMAX-T_{N1}-msg3-DeltaPreamble-messagePowerOffsetGroupB, the UE may select (at 612) a RACH preamble from a first subset of RACH preambles within the first group of RACH preambles, which RACH preambles are associated with a demand for Msg3 repetition. Otherwise, the UE may select (at 614) a RACH preamble from a second subset of RACH preambles (e.g., the Group A RACH preambles) within the first group of RACH preambles, which RACH preambles are not associated with a demand for Msg3 repetition. In accord with the pseudocode 600, Msg3 repetition with the second group of RACH preambles is not supported.

As shown in FIG. 7, the pseudocode 700 may be triggered when a UE determines (at 702) that a Msg3 buffer is empty and (at 704) that groupBconfigured is configured. If the UE then determines (at 706) that the Msg3 size is greater than ra-Msg3sizeGroupA and the downlink pathloss is less than PCMAX-preambleReceivedTargetPower-msg3-DeltaPreamble-T_{L2}, the UE may select (at 708) a RACH preamble from the second group of RACH preambles (e.g., the Group B RACH preambles). Otherwise, if the UE determines (at 710) that the downlink pathloss is less than PCMAX-preambleReceivedTargetPower-msg3-DeltaPreamble-Tx2, the UE may select (at 712) a RACH preamble from a first subset of RACH preambles within the first group of RACH preambles, which RACH preambles are associated with a demand for Msg3 repetition. Otherwise, the UE may select (at 714) a RACH preamble from a second subset of RACH preambles (e.g., the Group A RACH preambles) within the first group of RACH preambles, which RACH preambles are not associated with a demand for Msg3 repetition. In accord with the pseudocode 600, Msg3 repetition with the second group of RACH preambles is not supported. In some cases, the RACH preambles within the first subset of RACH preambles within the first group of RACH preambles may have a different size than the size of the RACH preambles within the second subset of RACH preambles within the first group of RACH preambles. The different size may indicate that the RACH preambles in the first subset are associated with a demand for Msg3 repetition.

In some cases, a combination of the options described with reference to FIGS. 6 and 7 may be provided. In some cases, a combination of the options described with reference to any of FIGS. 5-7 may be provided.

In some cases, additional parameters may be introduced to further split the second group of RACH preambles (e.g., the Group B RACH preambles) into a third subset of RACH preambles that is associated with Msg3 repetition and a fourth subset of RACH preambles that is not associated with Msg3 repetition.

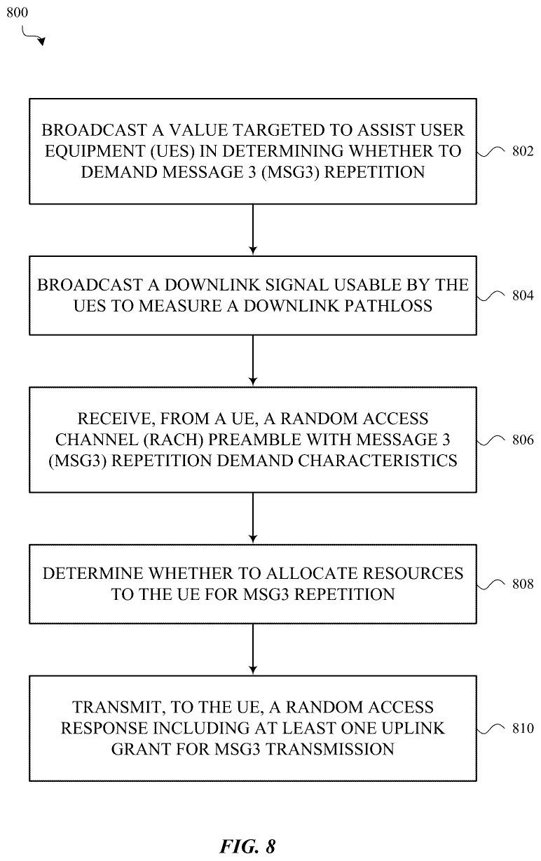

FIG. 8 shows an example method 800 of communication by a RAN (e.g., by a base station of a RAN), which method 800 may be used by the RAN to support Msg3 repetition by one or more UEs. The RAN or UE that performs the method 800 may be the RAN or UE described with reference to any of FIG. 1-7, 9, or 10.

At 802, the method 800 may include broadcasting a value targeted to assist UEs in determining whether to demand Msg3 repetition. In some embodiments, the operation(s) at 802 may be performed at 108 of the CBRA procedure described with reference to FIG. 1.

At 804, the method 800 may include broadcasting a downlink signal usable by the UEs to measure a downlink pathloss. In some embodiments, this signal may be an SS of an SSB (or different SSs in different SSBs). In some embodiments, the operation(s) at 804 may be performed at 108 of the CBRA procedure described with reference to FIG. 1.

At 806, the method 800 may include receiving, from a UE, a RACH preamble with Msg3 repetition demand characteristics. In some embodiments, the operation(s) at 806 may be performed at 112 of the CBRA procedure described with reference to FIG. 1.

At 808, the method 800 may include determining whether to allocate resources to the UE for Msg3 repetition. The RAN (or base station) may or may not allocate resources to the UE for Msg3 repetition, regardless of whether the UE made a demand for Msg3 repetition. The operation(s) at 808 may be performed at 114 of the CBRA procedure described with reference to FIG. 1.

At 810, the method 800 may include transmitting, to the UE, a random access response including at least one uplink grant for Msg3 transmission. In some embodiments, the random access response may include uplink grants for Msg3 repetitions. The operation(s) at 810 may be performed at 116 of the CBRA procedure described with reference to FIG. 1.

In some embodiments, the method 800 may include broadcasting a first RSRP threshold for SSB selection, and broadcasting a second RSRP threshold for SUL selection. In a first subset of these embodiments, the value targeted to assist UEs in determining whether to demand Msg3 repetition may include a third RSRP threshold for determining whether to demand Msg3 repetition on a NUL carrier. In a second subset of these embodiments, the value targeted to assist UEs in determining whether to demand Msg3 repetition may include a third RSRP threshold for determining whether to demand Msg3 repetition on a NUL carrier or on an SUL carrier. In a third subset of these embodiments, the value targeted to assist UEs in determining whether to demand Msg3 repetition may include a third RSRP threshold for determining whether to demand Msg3 repetition on a NUL carrier, and the method may further include broadcasting a fourth RSRP threshold for determining whether to demand Msg3 repetition on a SUL carrier.

In some embodiments, the method 800 may include associating a first group of RACH preambles (e.g., Group A RACH preambles) and a second group of RACH preambles (e.g., Group B RACH preambles) with an SSB, and broadcasting a first value of a target power for receiving the RACH preamble at the base station (e.g., preambleReceivedTargetPower). In these embodiments, the value targeted to assist UEs in determining whether to demand Msg3 repetition may include a second value of the target power for receiving the RACH preamble at the base station.

In some embodiments, the method 800 may include associating a first group of RACH preambles (e.g., Group A RACH preambles) and a second group of RACH preambles (e.g., Group B RACH preambles) with an SSB, and broadcasting a first value of a message power offset for RACH preamble selection (e.g., preambleReceivedTargetPower). In these embodiments, the value targeted to assist UEs in determining whether to demand Msg3 repetition may include a second value of a message power offset for RACH preamble selection (e.g., messagePowerOffsetGroupB).

Embodiments contemplated herein include an apparatus having means to perform one or more elements of the method 500 or 800. In the context of method 500, this apparatus may be, for example, an apparatus of a UE (such as a wireless device 1002 that is a UE, as described herein). In the context of method 800, this apparatus may be, for example, an apparatus of a base station (such as a network device 1018 that is a base station, as described herein).

Embodiments contemplated herein include one or more non-transitory computer-readable media storing instructions to cause an electronic device, upon execution of the instructions by one or more processors of the electronic device, to perform one or more elements of the method 500 or 800. In the context of method 500, this non-transitory computer-readable media may be, for example, a memory of a UE (such as a memory 1006 of a wireless device 1002 that is a UE, as described herein). In the context of method 800, this non-transitory computer-readable media may be, for example, a memory of a base station (such as a memory 1024 of a network device 1018 that is a base station, as described herein).

Embodiments contemplated herein include an apparatus having logic, modules, or circuitry to perform one or more elements of the method 500 or 800. In the context of method 500, this apparatus may be, for example, an apparatus of a UE (such as a wireless device 1002 that is a UE, as described herein). In the context of method 800, this apparatus may be, for example, an apparatus of a base station (such as a network device 1018 that is a base station, as described herein).

Embodiments contemplated herein include an apparatus having one or more processors and one or more computer-readable media, using or storing instructions that, when executed by the one or more processors, cause the one or more processors to perform one or more elements of the method 500 or 800. In the context of method 500, this apparatus may be, for example, an apparatus of a UE (such as a wireless device 1002 that is a UE, as described herein). In the context of the method 800, this apparatus may be, for example, an apparatus of a base station (such as a network device 1018 that is a base station, as described herein).

Embodiments contemplated herein include a signal as described in or related to one or more elements of the method 500 or 800.

Embodiments contemplated herein include a computer program or computer program product having instructions, wherein execution of the program by a processor causes the processor to carry out one or more elements of the method 500 or 800. In the context of method 500, the processor may be a processor of a UE (such as a processor(s) 1004 of a wireless device 1002 that is a UE, as described herein), and the instructions may be, for example, located in the processor and/or on a memory of the UE (such as a memory 1006 of a wireless device 1002 that is a UE, as described herein). In the context of method 800, the processor may be a processor of a base station (such as a processor(s) 1022 of a network device 1018 that is a base station, as described herein), and the instructions may be, for example, located in the processor and/or on a memory of the base station (such as a memory 1024 of a network device 1018 that is a base station, as described herein).

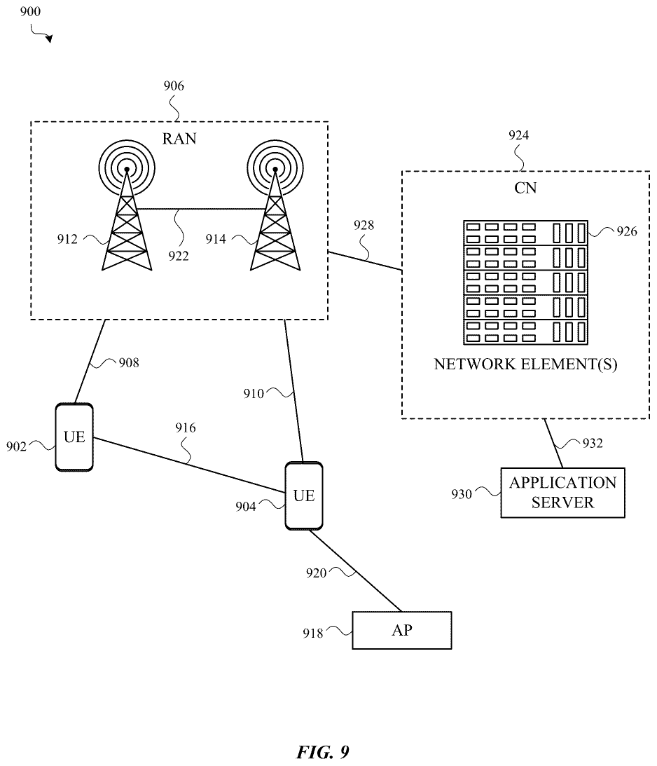

FIG. 9 illustrates an example architecture of a wireless communication system 900, according to embodiments disclosed herein. The following description is provided for an example wireless communication system 900 that operates in conjunction with the LTE system standards and/or 5G or NR system standards as provided by 3GPP technical specifications.

As shown by FIG. 9, the wireless communication system 900 includes UE 902 and UE 904 (although any number of UEs may be used). In this example, the UE 902 and the UE 904 are illustrated as smartphones (e.g., handheld touchscreen mobile computing devices connectable to one or more cellular networks), but may also comprise any mobile or non-mobile computing device configured for wireless communication.

The UE 902 and UE 904 may be configured to communicatively couple with a RAN 906. In embodiments, the RAN 906 may be NG-RAN, E-UTRAN, etc. The UE 902 and UE 904 utilize connections (or channels) (shown as connection 908 and connection 910, respectively) with the RAN 906, each of which comprises a physical communications interface. The RAN 906 can include one or more base stations, such as base station 912 and base station 914, that enable the connection 908 and connection 910.

In this example, the connection 908 and connection 910 are air interfaces to enable such communicative coupling, and may be consistent with RAT(s) used by the RAN 906, such as, for example, LTE and/or NR.

In some embodiments, the UE 902 and UE 904 may also directly exchange communication data via a sidelink interface 916. The UE 904 is shown to be configured to access an access point (shown as AP 918) via connection 920. By way of example, the connection 920 can comprise a local wireless connection, such as a connection consistent with any IEEE 802.11 protocol, wherein the AP 918 may comprise a Wi-Fi® router. In this example, the AP 918 may be connected to another network (for example, the Internet) without going through a CN 924.

In embodiments, the UE 902 and UE 904 can be configured to communicate using orthogonal frequency division multiplexing (OFDM) communication signals with each other or with the base station 912 and/or the base station 914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 912 or base station 914 may be implemented as one or more software entities running on server computers as part of a virtual network. In addition, or in other embodiments, the base station 912 or base station 914 may be configured to communicate with one another via interface 922. In embodiments where the wireless communication system 900 is an LTE system (e.g., when the CN 924 is an EPC), the interface 922 may be an X2 interface. The X2 interface may be defined between two or more base stations (e.g., two or more eNBs and the like) that connect to an EPC, and/or between two eNBs connecting to the EPC. In embodiments where the wireless communication system 900 is an NR system (e.g., when CN 924 is a 5GC), the interface 922 may be an Xn interface. The Xn interface is defined between two or more base stations (e.g., two or more gNBs and the like) that connect to 5GC, between a base station 912 (e.g., a gNB) connecting to 5GC and an eNB, and/or between two eNBs connecting to 5GC (e.g., CN 924).

The RAN 906 is shown to be communicatively coupled to the CN 924. The CN 924 may comprise one or more network elements 926, which are configured to offer various data and telecommunications services to customers/subscribers (e.g., users of UE 902 and UE 904) who are connected to the CN 924 via the RAN 906. The components of the CN 924 may be implemented in one physical device or separate physical devices including components to read and execute instructions from a machine-readable or computer-readable medium (e.g., a non-transitory machine-readable storage medium).

In embodiments, the CN 924 may be an EPC, and the RAN 906 may be connected with the CN 924 via an S1 interface 928. In embodiments, the S1 interface 928 may be split into two parts, an S1 user plane (S1-U) interface, which carries traffic data between the base station 912 or base station 914 and a serving gateway (S-GW), and the S1-MME interface, which is a signaling interface between the base station 912 or base station 914 and mobility management entities (MMEs).

In embodiments, the CN 924 may be a 5GC, and the RAN 906 may be connected with the CN 924 via an NG interface 928. In embodiments, the NG interface 928 may be split into two parts, an NG user plane (NG-U) interface, which carries traffic data between the base station 912 or base station 914 and a user plane function (UPF), and the S1 control plane (NG-C) interface, which is a signaling interface between the base station 912 or base station 914 and access and mobility management functions (AMFs).

Generally, an application server 930 may be an element offering applications that use internet protocol (IP) bearer resources with the CN 924 (e.g., packet switched data services). The application server 930 can also be configured to support one or more communication services (e.g., VOIP sessions, group communication sessions, etc.) for the UE 902 and UE 904 via the CN 924. The application server 930 may communicate with the CN 924 through an IP communications interface 932.

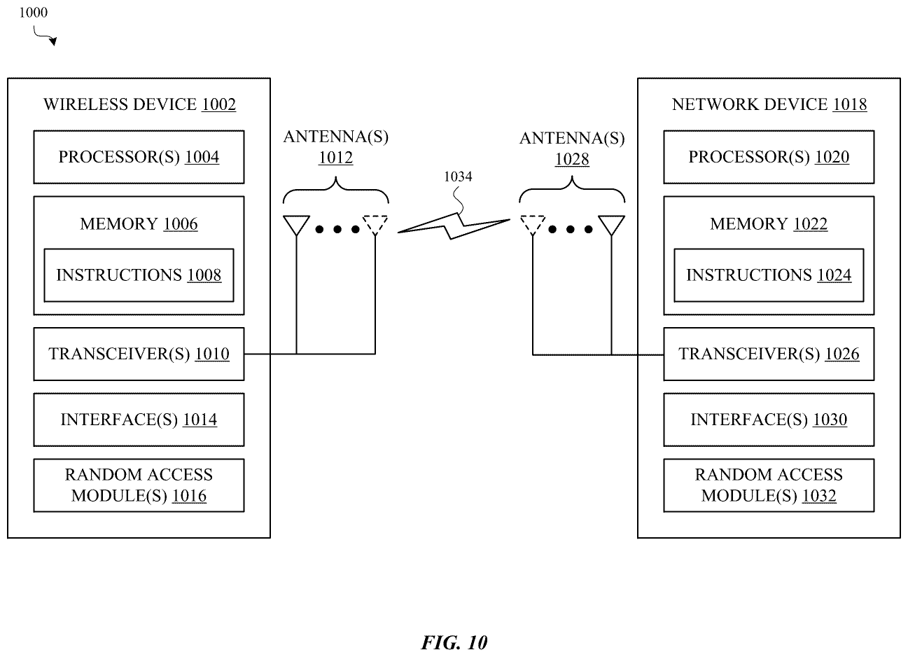

FIG. 10 illustrates a system 1000 for performing signaling 1034 between a wireless device 1002 and a network device 1018, according to embodiments disclosed herein. The system 1000 may be a portion of a wireless communications system as herein described. The wireless device 1002 may be, for example, a UE of a wireless communication system. The network device 1018 may be, for example, a base station (e.g., an eNB or a gNB) of a wireless communication system.

The wireless device 1002 may include one or more processor(s) 1004. The processor(s) 1004 may execute instructions such that various operations of the wireless device 1002 are performed, as described herein. The processor(s) 1004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1002 may include a memory 1006. The memory 1006 may be a non-transitory computer-readable storage medium that stores instructions 1008 (which may include, for example, the instructions being executed by the processor(s) 1004). The instructions 1008 may also be referred to as program code or a computer program. The memory 1006 may also store data used by, and results computed by, the processor(s) 1004.

The wireless device 1002 may include one or more transceiver(s) 1010 that may include radio frequency (RF) transmitter and/or receiver circuitry that use the antenna(s) 1012 of the wireless device 1002 to facilitate signaling (e.g., the signaling 1034) to and/or from the wireless device 1002 with other devices (e.g., the network device 1018) according to corresponding RATs.

The wireless device 1002 may include one or more antenna(s) 1012 (e.g., one, two, four, or more). For embodiments with multiple antenna(s) 1012, the wireless device 1002 may leverage the spatial diversity of such multiple antenna(s) 1012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1002 may be accomplished according to precoding (or digital beamforming) that is applied at the wireless device 1002 that multiplexes the data streams across the antenna(s) 1012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1002 may implement analog beamforming techniques, whereby phases of the signals sent by the antenna(s) 1012 are relatively adjusted such that the (joint) transmission of the antenna(s) 1012 can be directed (this is sometimes referred to as beam steering).

The wireless device 1002 may include one or more interface(s) 1014. The interface(s) 1014 may be used to provide input to or output from the wireless device 1002. For example, a wireless device 1002 that is a UE may include interface(s) 1014 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1010/antenna(s) 1012 already described) that allow for communication between the UE and other devices and may operate according to known protocols (e.g., Wi-Fi®, Bluetooth®, and the like).

The wireless device 1002 may include a random access module 1016. The random access module 1016 may be implemented via hardware, software, or combinations thereof. For example, the random access module 1016 may be implemented as a processor, circuit, and/or instructions 1008 stored in the memory 1006 and executed by the processor(s) 1004. In some examples, the random access module 1016 may be integrated within the processor(s) 1004 and/or the transceiver(s) 1010. For example, the random access module 1016 may be implemented by a combination of software components (e.g., executed by a DSP or a general processor) and hardware components (e.g., logic gates and circuitry) within the processor(s) 1004 or the transceiver(s) 1010.

The random access module 1016 may be used for various aspects of the present disclosure, for example, aspects of FIG. 1 through FIG. 9. The random access module 1016 may be configured to, for example, demand Msg3 repetition from another device (e.g., the network device 1018).

The network device 1018 may include one or more processor(s) 1020. The processor(s) 1020 may execute instructions such that various operations of the network device 1018 are performed, as described herein. The processor(s) 1020 may include one or more baseband processors implemented using, for example, a CPU, a DSP, an ASIC, a controller, an FPGA device, another hardware device, a firmware device, or any combination thereof configured to perform the operations described herein.

The network device 1018 may include a memory 1022. The memory 1022 may be a non-transitory computer-readable storage medium that stores instructions 1024 (which may include, for example, the instructions being executed by the processor(s) 1020). The instructions 1024 may also be referred to as program code or a computer program. The memory 1022 may also store data used by, and results computed by, the processor(s) 1020.

The network device 1018 may include one or more transceiver(s) 1026 that may include RF transmitter and/or receiver circuitry that use the antenna(s) 1028 of the network device 1018 to facilitate signaling (e.g., the signaling 1034) to and/or from the network device 1018 with other devices (e.g., the wireless device 1002) according to corresponding RATs.

The network device 1018 may include one or more antenna(s) 1028 (e.g., one, two, four, or more). In embodiments having multiple antenna(s) 1028, the network device 1018 may perform MIMO, digital beamforming, analog beamforming, beam steering, etc., as has been described.

The network device 1018 may include one or more interface(s) 1030. The interface(s) 1030 may be used to provide input to or output from the network device 1018. For example, a network device 1018 that is a base station may include interface(s) 1030 made up of transmitters, receivers, and other circuitry (e.g., other than the transceiver(s) 1026/antenna(s) 1028 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1018 may include a random access module 1032. The random access module 1032 may be implemented via hardware, software, or combinations thereof. For example, the random access module 1032 may be implemented as a processor, circuit, and/or instructions 1024 stored in the memory 1022 and executed by the processor(s) 1020. In some examples, the random access module 1032 may be integrated within the processor(s) 1020 and/or the transceiver(s) 1026. For example, the random access module 1032 may be implemented by a combination of software components (e.g., executed by a DSP or a general processor) and hardware components (e.g., logic gates and circuitry) within the processor(s) 1020 or the transceiver(s) 1026.

The random access module 1032 may be used for various aspects of the present disclosure, for example, aspects of FIG. 1 through FIG. 9. The random access module 1032 may be configured to, for example, receive demands for Msg3 repetition from another device (e.g., the wireless device 1002).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of wireless communication by a user equipment (UE), comprising:
receiving, from a radio access network (RAN), a value targeted to assist the UE in determining whether to demand message 3 (Msg3) repetition;
performing a measurement on a downlink signal;
determining to demand Msg3 repetition, the determination based at least in part on the value targeted to assist the UE in determining whether to demand Msg3 repetition and the measurement on the downlink signal; and
transmitting, to the RAN, a random access channel (RACH) preamble with Msg3 repetition demand characteristics.

2. The method of claim 1, further comprising:
receiving, from the RAN, a first reference signal received power (RSRP) threshold for synchronization signal block (SSB) selection; and
receiving, from the RAN, a second RSRP threshold for supplemental uplink (SUL) carrier selection.

3. The method of claim 2, wherein:
the value targeted to assist the UE in determining whether to demand Msg3 repetition comprises a third RSRP threshold;
determining to demand Msg3 repetition comprises determining a value of the measurement on the downlink signal is less than the second RSRP threshold or less than the third RSRP threshold; and
the RACH preamble is transmitted on a normal uplink (NUL) carrier.

4. The method of claim 2, wherein:
the value targeted to assist the UE in determining whether to demand Msg3 repetition comprises a third RSRP threshold;
determining to demand Msg3 repetition comprises,
determining the second RSRP threshold is less than the third RSRP threshold; and
determining a value of the measurement on the downlink signal is less than the second RSRP threshold; and
the RACH preamble is transmitted on a SUL carrier.

5. The method of claim 2, wherein:
the value targeted to assist the UE in determining whether to demand Msg3 repetition comprises a third RSRP threshold;
determining to demand Msg3 repetition comprises:
determining the second RSRP threshold is less than the third RSRP threshold; and
determining a value of the measurement on the downlink signal is between the second RSRP threshold and the third RSRP threshold; and
the RACH preamble is transmitted on a normal uplink (NUL) carrier.

6. The method of claim 2, wherein:
the value targeted to assist the UE in determining whether to demand Msg3 repetition comprises a third RSRP threshold;
determining to demand Msg3 repetition comprises:
determining the second RSRP threshold is greater than the third RSRP threshold; and
determining a value of the measurement on the downlink signal is less than the third RSRP threshold; and
the RACH preamble is transmitted on a normal uplink (NUL) carrier.

7. The method of claim 2, wherein:
the value targeted to assist the UE in determining whether to demand Msg3 repetition comprises a third RSRP threshold;
the method further comprises receiving, from the RAN, a fourth RSRP threshold;
determining to demand Msg3 repetition comprises:
determining the second RSRP threshold is between the third RSRP threshold and the fourth RSRP threshold; and
determining a value of the measurement on the downlink signal is between the second RSRP threshold and the third RSRP threshold; and
the RACH preamble is transmitted on the NUL carrier.

8. The method of claim 2, wherein:
the value targeted to assist the UE in determining whether to demand Msg3 repetition comprises a third RSRP threshold;
the method further comprises receiving, from the RAN, a fourth RSRP threshold;
determining to demand Msg3 repetition comprises:
determining the second RSRP threshold is between the third RSRP threshold and the fourth RSRP threshold; and
determining a value of the measurement on the downlink signal is less than the fourth RSRP threshold; and
the RACH preamble is transmitted on the SUL carrier.

9. The method of claim 2, wherein:
the value targeted to assist the UE in determining whether to demand Msg3 repetition comprises a third RSRP threshold;
the method further comprises receiving, from the RAN, a fourth RSRP threshold;
determining to demand Msg3 repetition comprises:
determining the third RSRP threshold is between the second RSRP threshold and the fourth RSRP threshold; and
determining a value of the measurement on the downlink signal is between the third RSRP threshold and the fourth RSRP threshold; and
the RACH preamble is transmitted on the NUL carrier.

10. The method of claim 2, wherein:
the value targeted to assist the UE in determining whether to demand Msg3 repetition comprises a third RSRP threshold;
the method further comprises receiving, from the RAN, a fourth RSRP threshold;
determining to demand Msg3 repetition comprises:
determining the third RSRP threshold is between the second RSRP threshold and the fourth RSRP threshold; and
determining a value of the measurement on the downlink signal is less than the fourth RSRP threshold; and
the RACH preamble is transmitted on the SUL carrier.

11. The method of claim 1, further comprising:
determining an availability of a first group of RACH preambles and a second group of RACH preambles; and
receiving, from the RAN, a first value of a target power for receiving the RACH preamble at the RAN; wherein,
the value targeted to assist the UE in determining whether to demand Msg3 repetition comprises a second value of the target power for receiving the RACH preamble at the RAN; and
determining to demand Msg3 repetition comprises:
determining to select the RACH preamble from the first group of RACH preambles based at least in part on the first value; and
determining to select the RACH preamble from a first subset of RACH preambles within the first group of RACH preambles based at least in part on the second value.

12. The method of claim 1, further comprising:
determining an availability of a first group of RACH preambles and a second group of RACH preambles; and
receiving, from the RAN, a first value of a message power offset for RACH preamble selection; wherein,
the value targeted to assist the UE in determining whether to demand Msg3 repetition comprises a second value of the message power offset for RACH preamble selection; and
determining to demand Msg3 repetition comprises:
determining to select the RACH preamble from the first group of RACH preambles based at least in part on the first value; and
determining to select the RACH preamble from a first subset of RACH preambles within the first group of RACH preambles based at least in part on the second value.

13. A user equipment (UE), comprising:
a transceiver; and
a processor configured to,
receive, from a radio access network (RAN) and via the transceiver, a value targeted to assist the UE in determining whether to demand message 3 (Msg3) repetition;
perform a measurement on a downlink signal received via the transceiver;
determine to demand Msg3 repetition, the determination based at least in part on the value targeted to assist the UE in determining whether to demand Msg3 repetition and the measurement on the downlink signal; and
transmit, to the RAN and via the transceiver, a random access channel (RACH) preamble with message 3 (Msg3) repetition demand characteristics.

14. The UE of claim 13, wherein:
the processor is configured to,
receive, from the RAN and via the transceiver, a first reference signal received power (RSRP) threshold for synchronization signal block (SSB) selection; and
receive, from the RAN and via the transceiver, a second RSRP threshold for supplemental uplink (SUL) selection; wherein,
the value targeted to assist the UE in determining whether to demand Msg3 repetition comprises a third RSRP threshold.

15. A method of wireless communication by a base station, comprising:
broadcasting a value targeted to assist user equipment (UEs) in determining whether to demand message 3 (Msg3) repetition;
broadcasting a downlink signal usable by the UEs to measure a downlink pathloss;
receiving, from a UE, a random access channel (RACH) preamble with message 3 (Msg3) repetition demand characteristics;
determining whether to allocate resources to the UE for Msg3 repetition; and
transmitting, to the UE, a random access response including at least one uplink grant for Msg3 transmission.

16. The method of claim 15, further comprising:
broadcasting a first reference signal received power (RSRP) threshold for synchronization signal block (SSB) selection; and
broadcasting a second RSRP threshold for supplemental uplink (SUL) selection; wherein,
the value targeted to assist UEs in determining whether to demand Msg3 repetition comprises a third RSRP threshold for determining whether to demand Msg3 repetition on a normal uplink (NUL) carrier.

17. The method of claim 15, further comprising:
broadcasting a first reference signal received power (RSRP) threshold for synchronization signal block (SSB) selection; and
broadcasting a second RSRP threshold for supplemental uplink (SUL) selection; wherein,
the value targeted to assist UEs in determining whether to demand Msg3 repetition comprises a third RSRP threshold for determining whether to demand Msg3 repetition on a normal uplink (NUL) carrier or on an SUL carrier.

18. The method of claim 15, further comprising:
broadcasting a first reference signal received power (RSRP) threshold for synchronization signal block (SSB) selection; and
broadcasting a second RSRP threshold for supplemental uplink (SUL) selection; wherein,
the value targeted to assist UEs in determining whether to demand Msg3 repetition comprises a third RSRP threshold for determining whether to demand Msg3 repetition on a normal uplink (NUL) carrier; and
the method further comprises broadcasting a fourth RSRP threshold for determining whether to demand Msg3 repetition on a supplemental uplink (SUL) carrier.

19. The method of claim 15, further comprising:
associating a first group of RACH preambles and a second group of RACH preambles with a synchronization signal block (SSB); and
broadcasting a first value of a target power for receiving the RACH preamble at the base station; wherein,
the value targeted to assist UEs in determining whether to demand Msg3 repetition comprises a second value of the target power for receiving the RACH preamble at the base station.

20. The method of claim 15, further comprising:
associating a first group of RACH preambles and a second group of RACH preambles with a synchronization signal block (SSB); and
broadcasting a first value of a message power offset for RACH preamble selection; wherein,
the value targeted to assist UEs in determining whether to demand Msg3 repetition comprises a second value of the message power offset for RACH preamble selection.
